(19) United States
(12) Patent Application Publication
(10) Pub. No.: US 2003/0144025 A1
(43) Pub. Date: Jul. 31, 2003

(54) Restricting usage of digital objects associated with a wireless LAN

(75) Inventor: Stuart Philip Stenton, Gloucestershire (GB)

Correspondence Address: HEWLETT-PACKARD COMPANY, Intellectual Property Administration, P.O. Box 272400, Fort Collins, CO, 80527-2400, US

(73) Assignee: HEWLETT-PACKARD COMPANY

(21) Appl. No.: 10/353,519

(22) Filed: Jan. 28, 2003

(30) Foreign Application Priority Data
Jan. 30, 2002 (GB) 0202136.8

(51) Int. Cl. H04B 1/38

(52) U.S. Cl. 455/554; 455/555

(57) ABSTRACT

Wireless LANs can be used to provide connectivity over limited areas such as public spaces and publicly-accessible premises, both commercial and non-commercial. A variety of digital objects can be made available via a wireless LAN which can enhance the experience of persons in its coverage zone. Indeed, the availability of such digital objects (such as unusual graphic images and readings by authors of their works) can be a strong incentive for people to frequent the coverage zone. This obviously has application to premises wishing to attract people. However, the incentive to visit provided by the digital objects is degraded rapidly if it becomes easy to download copies of the digital objects into a mobile device and take them away for future enjoyment. In order to limit such activity, functionality required by mobile devices to make use of the digital objects, is so arranged that in order to operate, it requires the continual reception of enabling signals from a wireless LAN of a restricted group of wireless LANs with which the digital object is associated.

### FIELD OF THE INVENTION

The present invention relates to restricting usage of digital objects associated with a wireless LAN (local area network).

### BACKGROUND OF THE INVENTION

Wireless LANs are gaining substantial acceptance as a means for providing connectivity over a restricted area to mobile devices. Whilst there are a number of different wireless LAN architectures and the present invention is not limited to any particular one, the following description is generally written using the terminology applied in the ANSI/IEEE Standard 802.11 (“Wireless LAN Medium Access Control and Physical Layer Specifications”). More particularly, FIG. 1 of the accompanying drawings illustrates the main components of a wireless LAN using that terminology. Thus, a typical wireless LAN 5 comprises a distribution system 10 that serves to interconnect a number of access points (AP) 11 via a network. Each access point 11 connects with mobile stations (MS) 12 over a wireless medium to form a Basic Service Set 13 (BSS1 and BSS2). The totality of the basis service sets and the network that interconnects them is called an Extended Service Set (ESS). The wireless LAN may connect with other networks via a portal 15. The term “wireless LAN core” is used herein to refer to the permanent infrastructure of a wireless LAN, namely its distribution system with associated wireless access points, and any functional systems connected to the distribution system (such as, for example, storage systems).

Wireless LANs can be used to provide connectivity over limited areas such as public spaces and publicly-accessible premises, both commercial and non-commercial. By connecting servers or similar data stores to the distribution system network, a variety of digital objects can be made available via a wireless LAN independently of any external network connection. Such digital objects can enhance the experience of persons with mobile stations (also called devices below) in the coverage zone of the wireless LAN. Indeed, the availability of digital objects such as unusual graphic images and readings by authors of their works, can be a strong incentive for people to frequent the coverage zone. This can be used by premises wishing to attract people. For example, a coffee shop wanting to attract artistic customers can make available a suitable collection of digital objects via a wireless LAN set up to cover substantially only the coffee shop (at least in terms of the coverage offered by the access points of the wireless LAN).

However, the incentive to visit such a premises that is provided by the digital objects may degrade rapidly if it easy to download copies of the digital objects into a mobile device and then take them away for future enjoyment.

It is an object of the present invention to reduce the misuse of digital objects associated with wireless LANs.

### SUMMARY OF THE INVENTION

According to one aspect of the present invention, there is provided a system comprising:

a plurality of wireless LAN cores each comprising a distribution system with access points, and enablement means in communication with the distribution system for wirelessly transmitting a succession of enabling signals via said access points;

a mobile device for communicating by wireless with a said wireless LAN core; and

association arrangement for associating a digital object with multiple said wireless LAN cores,

the mobile device including:

receiving means for receiving said enabling signals from a said wireless LAN core; and

a processing arrangement for carrying out processing of a digital object, the processing arrangement being such that the processing of a digital object associated with multiple said wireless LAN cores is only carried out whilst enabling signals are received at the device from any one of the said wireless LAN cores with which the object is associated, the object being retained in the device absent the receipt of such enabling signals.

According to another aspect of the present invention, there is provided a method of controlling usage of a digital object by a mobile device, the method comprising the steps of:

(a) associating the object with multiple wireless LANs;

(b) transmitting from each of said multiple wireless LANs a succession of enabling signals;

(c) receiving, at the mobile device, enabling signals from a wireless LAN; and

(d) carrying out, at the mobile device, processing of said digital object only whilst enabling signals are received in step (c) from at least one of the said wireless LAN cores with which the object is associated, the object being retained in the device in the absence of such enabling signals.

### BRIEF DESCRIPTION OF THE DRAWINGS

Embodiments of the invention will now be described, by way of non-limiting example, with reference to the accompanying diagrammatic drawings, in which:

FIG. 1 is a diagram of a known wireless LAN architecture;

FIG. 2 is a diagram of a first embodiment of the invention; and

FIG. 3 is a diagram of a second embodiment of the invention.

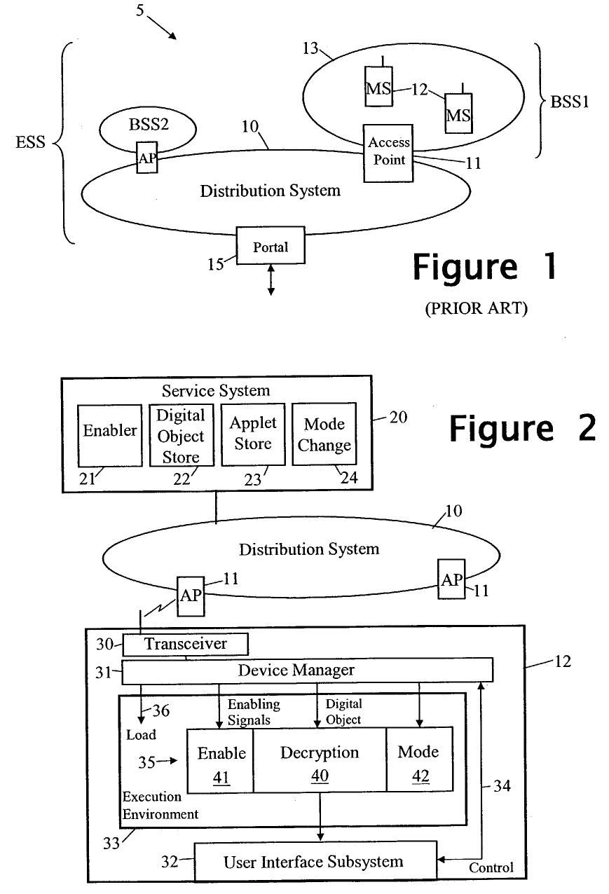

### BEST MODE OF CARRYING OUT THE INVENTION

The wireless LAN shown in FIG. 2 comprises a wireless LAN core formed by distribution system 10, access points 11 and a service system 20 connected to the distribution system 10. A mobile device 12 of the wireless LAN is in communication with the wireless LAN core through one of the access points 11 (though not necessarily directly).

The service system 20 comprises an enabler 21 for generating an on-going succession of enabling signals for transmission to the mobile device, a store 22 for storing digital objects of one or more media types, a store 23 for storing applets for download to the mobile device, and a mode control block 24.

The mobile device 12 comprises a wireless transceiver 30, a user interface subsystem 32, and a device manager 31 providing basic control functions for the mobile device in response to user input from subsystem 32 (arrow 34) and input received via the transceiver 30. The device further comprises an execution environment 33 for running applets 35 downloaded from the applet store 23 of the service system 20.

The user of device 12 can contact the service system via access point 11 and distribution system 10 to request the download of a selected digital object held in store 22. The selected object 35 is arranged to be delivered to the mobile device 12 in encrypted form (either being stored in encrypted form or being encrypted at the time of download).

At the same time as the encrypted object is downloaded to the mobile device, a decryption applet 35 for decrypting the encrypted digital object is also delivered from the applet store 23 to the mobile device. This applet is loaded into the execution environment 33 of the mobile device 33 (see arrow 36). Functionally, the applet 35 comprises a digital-object decryption function 40, an enablement function 41, and a mode function 42. The mode function 42 sets the operational mode of the applet, the latter normally being delivered to the device in a default mode in which the decryption function 40 requires enablement from the enablement function 41 in order to decrypt the digital object downloaded from the system 20.

With the applet 35 in its default mode of operation, the enablement function 41 is arranged to enable the decryption function 40 in the presence of enabling signals from the same wireless LAN core as the digital object to be decrypted. The enabling signals are provided by the enabler 21 of the service system 21 and are received by the mobile device 12 whilst within the wireless coverage of the wireless LAN.

Various mechanisms can be used to ensure that the enablement function 41 only enables the decryption function 40 in the presence of enabling signals from the same wireless LAN core as that from which the digital object to be decrypted was received. In one mechanism, the digital object and enabling signals originating from the same wireless LAN core are tagged in a way to indicate their common origin, and the enablement function 41 is arranged to enable the decryption function 40 only if the object to be decrypted and the currently-received enabling signals have the same origin. This tagging can be achieved, for example, by tagging both the object and enabling signals in the service system 20 either with an object specific ID or with a wireless LAN core ID. In a variant, the tagging of one or both of the object and enabling signals with wireless LAN core ID is done by the mobile device transceiver 30 as it receives them (it being assumed that the transceiver will be aware of an identity for the wireless LAN core with which it is currently communicating); indeed, rather than this tagging explicitly identifying a wireless LAN core, the transceiver can simply indicate which objects and enabling signals come from the same wireless LAN core.

It will be appreciated in respect of the foregoing tagging mechanism, that the term “tagging” is to be broadly understood as regards how an object or the enabling signals are marked. It will be further appreciated-that a digital object can be tagged with an identifier associated with a particular wireless LAN core remotely of that core and, indeed, the object need not necessarily be provided to the mobile device via the wireless LAN core with which it is associated.

In order to prevent objects or enabling signals being falsely tagged by persons wishing to circumvent the limitations imposed by the enablement function 41, the tags can be digitally signed on behalf of the wireless LAN core concerned, the enablement function 41 then being arranged to check, in known manner, the validity of the tag.

Mechanisms other than tagging are also possible for ensuring that the enablement function 41 only enables the decryption function 40 in the presence of enabling signals from the wireless LAN core with which the digital object to be decrypted is associated. Thus, in another mechanism, a digital object associated with a particular wireless LAN core is encrypted such that it can only be decrypted by a decryption applet provided by the same wireless LAN core, this applet then only being enabled by enabling signals from that wireless LAN core (and possibly specific to that applet). This mechanism can be used with other forms of conditioning applied to the digital object which only a specific applet can process successfully.

Whatever mechanism is used to relate the enabling signals to objects associated with the same LAN core as the signals, whilst the enablement function 41 enables the decryption function 40, this function operates to decrypt the digital object, the decrypted object being output to the user via the user interface subsystem 32.

From the foregoing it can be seen that should the mobile device 12 be moved out of the coverage zone of the wireless LAN with which the downloaded digital object is associated, the decryption function will cease to be enabled as the enablement function will cease to receive the required flow of enabling signals. To further reduce the risk of the digital object being used beyond the coverage zone of that wireless LAN, the applet 35 can be arranged to remove the digital object (or at least any decrypted portions) from the device after the elapse of a predetermined period since the last-received enabling signal from the wireless LAN concerned. Indeed, for added security, even whilst appropriate enabling signals are being received, any decrypted portions of the object that are no longer required should be removed.

With respect to the mode function 42, this enables the applet to be switched from its default mode in which operation of the decryption function requires the function to be enabled from the enablement function, into a mode in which it is enabled all the time, at least for specific objects. This change of mode is, in the present example, controlled by the mode control block 24 of the service system, this block causing the applet to change to its always-enabled mode (at least for a specific object) upon occurrence of a particular event such as payment by the user of the mobile device of a one-time licence fee.

The mobile device and wireless LAN core can be provided with appropriate means for uploading digital objects from the device to the digital object store 42, these objects then being treated as objects associated with the wireless LAN core.

It is to be understood that the functionality provided by the applet 35 need not be a decryption function but can be any functionality involved in presenting a digital object to the user whereby absent enabling signals from the same LAN core as that with which the digital object is associated, the object is not presented to the user. Indeed, where the object has a non-presentational purpose, the functionality provided by the applet 35 can be any required to be effected in relation to the object in order to achieve that purpose.

Furthermore, whilst in the FIG. 2 embodiment the functionality that is only enabled in the presence of appropriate enabling signals, is provided in the form of downloaded applets distinct from the digital objects, the functionality can be otherwise provided, for example, embedded in the digital objects or permanently installed in the mobile device.

In the foregoing, it has been assumed that each digital object is only associated with one wireless LAN core (in particular, in the case of the FIG. 2 embodiment, the wireless LAN core storing the digital object). However, it is possible to associate a digital object with more than one wireless LAN core, for example by tagging the object with markings identifying multiple wireless LAN cores either by respective specific IDs or by a group ID (thus, a digital object downloaded from one wireless LAN core can be arranged to carry tags indicating multiple wireless LAN cores where it can be used). In this case, provided retention of the digital object in the mobile device is permitted absent related enabling signals, the digital object can be transported from the original wireless LAN where it was downloaded into the mobile device, to another wireless LAN core with which it is associated where it is again usable as a result of the enabling signals output from that wireless LAN core re-enabling the functionality for processing the digital object. The simplest association mechanism for implementing multiple associations (whether individually or by a group designation) is the use of tags as just described; however, other mechanisms are possible including by marking the enabling signals of multiple cores with the identities of objects for which the enabling signals are effective. An advantage of multiple associations is that it permits a digital object to be used in any of a commonly controlled group of premises covered by respective wireless LANs.

Where a digital object has multiple associations, it may be useful to temporarily render inoperative all but one association so that the digital object can only be used in the coverage zone of one particular wireless LAN. For example, where a digital object relates to a transaction (or other processing operation) that must go through all its steps whilst the mobile device is communicating with the same wireless LAN in order for the object to contain valid data, then at the start of the transaction the mobile device can mark all but the association with the wireless LAN core concerned as temporarily inoperative; upon completion of the transaction, the associations are all restored to an operative status. Should the transaction be interrupted before completion, the digital object cannot be used elsewhere until the transaction is complete.

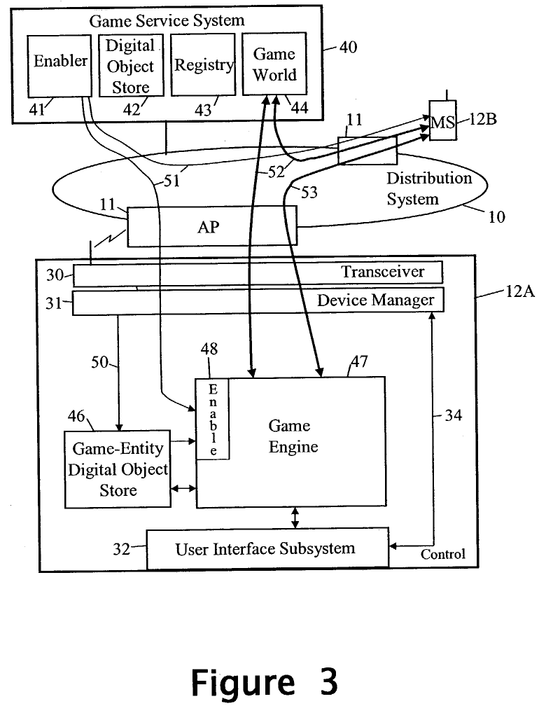

The FIG. 3 embodiment now to be described has enabling-signal-controlled functionality permanently installed in the mobile device, this functionality being a game engine 47. More particularly, the wireless LAN core of the FIG. 3 embodiment includes a game service system 40 for facilitating the playing of a virtual game involving virtual game entities (typically, human or robot characters) controlled through respective mobile devices 12A, 12B in wireless communication with the service system 40. The virtual game entities are represented by digital objects that each contain the entity attributes necessary to characterise the entity; typically these attributes will comprise permanent (or semi-permanent) attributes that specify the game entity and variable attributes that represent depletable resources such as energy, lives, weapons etc. In the present example, the game-entity digital objects are permanently stored in an object store 42 of the system 40 and are treated as associated with the wireless LAN core that includes the store 40. To participate in a virtual game, a user uses their mobile device (e.g. device 12A) to contact the service system 40 and register for a selected game entity via a registry function 43; a copy of the game-entity digital object is then downloaded to the mobile device 12A for storage in store 46 (see arrow 50). The digital object has an associated identity.

As for the FIG. 2 embodiment, each mobile device 12A, 12B comprises a transceiver, device manager 31, and user interface 32. In addition, as already indicated, each device also has a game engine 47. This game engine includes an enablement function 48 that is operative to enable the game engine only whilst receiving enabling signals carrying the identity of the game-entity digital object downloaded to the store 46, such signals being provided from an enabler 41 of the service system 41. In this manner, a game-entity object downloaded from the service system 40 can only be used in a game whilst enabling signals are being received from the same service system.

Game service system 40 further comprises a game-world subsystem responsible for generating the virtual game world in which the game entities move and interact with each other, the game-world subsystem also being responsible for keeping track of the game entities in the game world. The game-world subsystem 44 passes game-world display data to the game engines 47 of the mobile devices 12A, 12B controlling game entities in the game (see arrows 52), the display data sent to a game engine being dependent on the position of the corresponding game entity as determined in dependence on movement data sent by the game engines to the game-world subsystem. When the game-world subsystem 44 determines that two game entities are within an interaction distance of each other, it informs the corresponding game engines 47 and thereafter interaction of the game entities is controlled by the exchange of data between the game engines via the wireless LAN (see arrow 53).

The game engines 47 are responsible for modifying the values of the variable attributes of their corresponding game entities and for producing a suitable output via user interface subsystem 32 showing how the game entity is doing in the game world.

Whenever a user decides to disengage their game entity from the game (or upon the game being over for the entity), the game engine 47 can simply delete the game-entity digital object and inform the registry 43. Alternatively, the game engine can cause the current values of the game-entity attributes to be written back to the store 42, either replacing the existing stored attribute values for the game entity concerned, or storing them in a distinct copy of the game-entity digital object that is associated with the particular user concerned. In this latter case, the user can subsequently reclaim that copy of the game-entity digital object for future games.

In order to ensure that the identity of a game-entity digital object downloaded from a wireless LAN core cannot be easily removed, the identity can be embedded in the digital object for example by a known digital watermarking technique.

The mobile device store 46 can also be used to store, on a long term basis, the user's own game-entity digital objects. Such a user game-entity object can have one or more permanent associations with corresponding wireless LAN cores; for example, where a user has created their own game entity using a template provided by the game service system of a particular wireless LAN core, that game entity may carry a permanent association with that core whereby the game entity can only be used in games hosted by the game system of the core concerned. Alternatively, a user game-entity object may have no associations and for such cases the enablement function 48 is preferably arranged to enable the game engine 47 to use that game-entity digital object in any game independently of the presence of enabling signals from an enabler 41 (thus, the game entity could, for example, be used in a game hosted by the game service system 40 with the registry 43 being responsive to being informed that the game entity object has no associations, to suppress the sending out of enabling signals to the mobile device concerned; the registry simply notes the ID of the mobile device controlling the game entity).

In fact, as will become clear below, there are advantages in arranging for a user game-entity digital object that has no permanent associations, being given a temporary association when engaged in a game hosted by a game service system 40, this association being set up (for example, by storing the ID of the relevant wireless LAN core in an attribute of the game entity object) when the game entity is first engaged in the game through the game system registry 43, and being removed upon disengagement of the game entity from the game. During engagement of the game entity in the game, the enablement function now requires the presence of enabling signals from the relevant game service system to enable the game engine 47. Furthermore, where a temporary association is set up upon a user game entity being engaged in the game, the registry 43 is arranged to cause the enabler 41 to send out to the relevant mobile device enabling signals in respect of the game entity object concerned.

One reason for providing for such temporary associations, concerns the involvement of the game entity in a game from which it can only be disengaged under certain conditions, not including cessation of communication between the mobile and game system; such conditions may include the game entity achieving a particular goal in the game such as reaching a particular location, finding a particular game object, or defeating a particular enemy. The registry 43 is arranged to determine when a game entity can be disengaged on the basis of input from the game world subsystem, only allowing (or forcing) disengagement under the appropriate conditions. Upon the registry determining disengagement of a game entity from a game, it informs the relevant mobile device which thereupon removes the temporary association of the game entity object with the relevant game service system. Whilst the game entity remains engaged in the game, its temporary association with the game system 40 is recognised by game-engagement logic in the mobile device and used to prevent the user engaging the game entity in any other game—in other words, only one temporary association is allowed at a time. This arrangement ensures that the user must disengage their game entity in an appropriate manner from the game before engaging in another (merely ceasing communication with the game system being inadequate to disengage the game entity and remove the association). A further guarantee of this would be for the game service system to store a continually updated copy of the game entity object (together with the ID of the related mobile-device or user) whilst the game entity was engaged in the game, the enablement means (or some other element of the mobile device) then being arranged to delete the game-entity object from the store 46 if the enabling signals cease for a sustained period whilst the game entity is engaged in a game. As a result, the mobile device ceases to store the object and needs to re-connect to the game system to continue the game, re-connection resulting in the copy of the game-entity object stored in the game system being downloaded back into the store 46 of the mobile device.

In the event that a game entity is left engaged in a game by a mobile device that is no longer in communication with the game system, the latter is preferably arranged to set the game entity in a dormant state in which, at least for a predetermined period, the entity cannot be attacked or otherwise interacted with by other game entities in the game. Provision may also be made (particularly if the game system holds the only copy of the game entity object), for the game system to “capture” a game entity object that has been left engaged in the game for a prolonged period; by capture is meant that the game entity object ceases to be treated as associated with the mobile device/user that engaged it in the game; the captured game entity object could, for example, be transferred to a pool of game entity object such as store 42.

The temporary association of a user-provided digital object with a wireless LAN core can, of course, be effected for objects other than game entity objects. Permitting use of only a single temporary association is particularly appropriate where the object is to be used with any wireless LAN in relation to a process run by a service system of the latter, but the object needs to remain engaged in the process until a predetermined disengagement state is reached.

It will be appreciated that many other variants are possible to the above described embodiments of the invention. Thus, a degree of assurance regarding the validity of the enabling signals can be achieved by giving the signals a value that varies with time in a pseudo-random manner predictable by the mobile device on the basis of a secret shared with the wireless LAN core sourcing the signals, the device being operative to recognize an enabling signal only if it has a predicted value.

Although in the described embodiments the enabling signals are generated automatically by the enabler of the wireless LAN core (at least after being initiated in respect of a mobile device or object), it is also possible to arrange for each successive enabling signal to be triggered by a request from the mobile device, the request being generated, for example, by the functionality to be enabled. Each enabling signal serves, of course to enable the functionality for a limited period, typically no more than a small integer multiple of the normal cycle time between receipt of successive enabling signals.

1. A system comprising:
a plurality of wireless LAN cores each comprising a distribution system with access points, and enablement means in communication with the distribution system for wirelessly transmitting a succession of enabling signals via said access points;
a mobile device for communicating by wireless with a said wireless LAN core; and
an association arrangement for associating a digital object with multiple said wireless LAN cores,
the mobile device including:
receiving means for receiving said enabling signals from a said wireless LAN core; and
a processing arrangement for carrying out processing of a digital object, the processing arrangement being such that the processing of a digital object associated with multiple said wireless LAN cores is only carried out whilst enabling signals are received at the device from any of the said wireless LAN cores with which the object is associated, the object being retained in the device absent the receipt of such enabling signals.

2. A system according to claim 1, further comprising means for temporarily rendering inoperative all but one association of a digital object with multiple wireless LAN cores whereby the digital object can temporarily only be used in the coverage zone of one wireless LAN core.

3. A system according to claim 2, wherein said means for temporarily rendering inoperative all but one association of a digital object, is arranged to do so upon said processing arrangement of the mobile device initiating particular processing in relation to the digital object such that said particular processing can only be completed whilst the processing arrangement is receiving enabling signals from the wireless LAN core that is still operatively associated with the object; said means for temporarily rendering inoperative all but one association of a digital object, being further arranged to restore the temporarily inoperative associations upon completion of said particular processing.

4. A system according to claim 1, wherein said association arrangement for associating a digital object with multiple wireless LAN cores comprises tagging means for tagging the digital object and the enabling signals of these cores in a manner such that said processing arrangement can determine whether the digital object and enabling signals received by it are both associated with a wireless LAN core of said multiple wireless LAN cores.

5. A system according to claim 4, wherein the tagging means comprises a first part for tagging digital objects with an identifier of the latter, and a second part for tagging the enabling signals at each of said multiple wireless LAN cores also with the same said identifier.

6. A system according to claim 4, wherein the tagging means comprises a first part for tagging digital objects with identifiers of each of said multiple wireless LAN cores, and a second part for tagging, at each of said multiple wireless LAN cores, the enabling signals of that core with the corresponding wireless LAN core identifier.

7. A system according to claim 4, wherein the tagging means comprises a first part for tagging digital objects with a group identifier identifying said multiple wireless LAN cores, and a second part for tagging the enabling signals at each of said multiple wireless LAN cores also with said group identifier.

8. A system according to claim 1, wherein said association arrangement for associating a digital object with at least one said wireless LAN comprises means for conditioning the digital object such that said processing can either only be carried out using elements of said processing arrangement provided to the mobile device by a said wireless LAN core of said multiple wireless LAN cores or only be enabled by the enabling signals from such core.

9. A system according to claim 1, wherein said association arrangement for associating a digital object with multiple wireless LAN is operative to effect such an association between a digital object provided by the mobile device and a particular wireless LAN core on a temporary basis whilst that digital object is engaged in a process involving a service system of said particular wireless LAN core.

10. A system according to claim 1, wherein at least one said wireless LAN core comprises a store for storing digital objects intended for presentation to a user of said device with the aid of said processing arrangement, and the mobile device further includes means for downloading a digital object from the store; digital objects downloaded from the store being treated as associated with said multiple wireless LAN cores.

11. A system according to claim 10, wherein the mobile device includes a program execution environment operative to run program code provided by the wireless LAN core along with downloaded digital objects, said program code when executing providing at least part of said processing arrangement.

12. A system according to claim 1, wherein said processing arrangement is embedded in a said digital object that is to undergo processing by the processing arrangement.

13. A system according to claim 1, wherein the mobile device further includes exclusive-association means operative, at the commencement of processing by said processing arrangement of a digital object associated with multiple wireless LAN cores, to render inoperative all such associations except that with the wireless LAN core from which enabling signals are currently being received, said exclusive-association means being further operative to return all said associations to an operative state only after a predetermined processing state has been reached.

14. A method of controlling usage of a digital object by a mobile device, the method comprising the steps of:
(a) associating the object with multiple wireless LANs;
(b) transmitting from each of said multiple wireless LANs a succession of enabling signals;
(c) receiving, at the mobile device, enabling signals from a wireless LAN; and
(d) carrying out, at the mobile device, processing of said digital object only whilst enabling signals are received in step (c) from at least one of the said wireless LAN cores with which the object is associated, the object being retained in the device in the absence of such enabling signals.

15. A method according to claim 14, further comprising the step of temporarily rendering inoperative all but one association of the digital object with multiple wireless LAN cores whereby the digital object is temporarily only usable in the coverage zone of one wireless LAN core.

16. A method according to claim 15, wherein the step of temporarily rendering inoperative all but one association of the digital object, is effected in coordination with initiation in step (d) of particular processing of the digital object enabled by the receipt of enabling signals from one of the wireless LANs, the association of this LAN with the digital object being maintained operative whilst the other associations are rendered inoperative; the associations temporarily rendered inoperative being restored only after said particular processing has been completed.

17. A method according to claim 14, wherein step (a) comprises tagging the digital object and the enabling signals of said multiple LANs in a manner such that in step (d) processing of the digital object is only effected where inspection of the digital object and the received enabling signals determines that both are associated with a wireless LAN of said multiple wireless LANs.
